(19) United States
(12) Patent Application Publication
(10) Pub. No.: US 2010/0026142 A1
(43) Pub. Date: Feb. 4, 2010

(54) HUMAN ENERGY HARVESTING AND STORAGE SYSTEM

(75) Inventors: Thomas A. Jones, Macomb, MI (US); Wade W. Bryant, Grosse Pointe Farms, MI (US); Cristian Farcas, Royal Oak, MI (US); Therese A. Tant, Royal Oak, MI (US); Kurt D. Zeile, Lake Orion, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/432,593

(22) Filed: Apr. 29, 2009

Related U.S. Application Data
(60) Provisional application No. 61/085,160, filed on Jul. 31, 2008.
(60) Provisional application No. 61/146,926, filed on Jan. 23, 2009.

(51) Int. Cl. F03G 5/06; H02N 2/18

(52) U.S. Cl. 310/339; 180/333; 290/1 R; 310/319

(57) ABSTRACT

A human energy harvesting and storage system that captures energy from various human activities and stores that energy on a vehicle to be used for various vehicle applications. In one embodiment, piezoelectric devices, or other types of energy generating devices, are provided in the seat of the vehicle that generate electricity from the weight and movement of a person sitting in the seat that is collected by a suitable electrical storage device. The electrical storage device provides power to a power port in the vehicle so that various devices can be plugged into the power port to be operated. In alternate embodiments, the energy is collected outside of the vehicle by human activity, and the storage device is brought into the vehicle to be plugged into the power port.

### CROSS-REFERENCE TO RELATED APPLICATIONS

This application claims the benefit of the filing dates of U.S. Provisional Application Ser. No. 61/085,160, titled Human Energy Harvesting and Storage System, filed Jul. 31, 2008 and U.S. Provisional Application Ser. No. 61/146,926, titled Power Generating Crank, filed Jan. 23, 2009.

### BACKGROUND OF THE INVENTION

1. Field of the Invention

This invention relates generally to a system and method for harvesting energy from human activity and, more particularly, to a system and method for harvesting energy from human activity, providing that energy to a storage device on a vehicle and using the energy for vehicle related devices.

2. Discussion of the Related Art

Every person has a carbon footprint that defines how much carbon dioxide is emitted into the air as a result of a person's activities. Carbon dioxide may trap heat in the atmosphere, which may have a detrimental effect on the environment. Various human activities that generate carbon dioxide include operating various energy consuming devices, such as vehicles, appliances, lights, etc. There has been a considerable effort by individuals and groups in at least certain industrialized nations to reduce a person's carbon footprint by reducing the amount of energy that they consume.

It has been proposed in the art to capture energy from certain human activities, such as walking. For example, a knee brace has been proposed that includes an energy generating device and an energy storage device that captures energy as a result of a person walking. The energy is stored in the storage device and is then available to operate various low power devices, such as portable GPS locators, cell phones, iPods, etc.

It may be desirable to extend the idea of harvesting human energy and employing that energy in various other manners.

### SUMMARY OF THE INVENTION

In accordance with the teachings of the present invention, a human energy harvesting and storage system is disclosed that captures energy from various human activities, and stores that energy on a vehicle to be used for various vehicle applications. In one embodiment, piezoelectric devices, or other types of energy generating devices, are provided in the seat of the vehicle that generate electricity from the weight and movement of a person sitting in the seat that is collected by a suitable electrical storage device. The electrical storage device provides power to a power port in the vehicle so that various devices can be plugged into the power port to be operated. In alternate embodiments, the energy is collected outside of the vehicle by human activity, and the storage device is brought into the vehicle to be plugged into the power port. Further, the system can employ an active process for collecting the energy from a vehicle operator, such as pushing on a foot rest, gripping the steering wheel, gripping the shift knob, rubbing the vehicle carpet, etc. Static electricity brought into, or generated within the vehicle, could also be collected.

In another embodiment, a system and method are provided for collecting electrical energy from a multifunctional manual crank, such as a manual window crank on a vehicle. The crank is coupled to a generator so that when the crank is rotated, the generator also rotates and generates electrical energy that can be transferred to an electrical storage device to be stored for later use. If the manual crank is a window crank, or a crank for some other vehicle device, a switch can be provided to engage and disengage the crank from a window gear so that the crank can be turned to generate the electrical energy without raising and lowering the window. Alternatively, the manual crank can be a stand-alone power generating crank that is separate from an actual vehicle system where turning the crank has the sole purpose for generating electricity that can be stored for some other use.

Additional features of the present invention will become apparent from the following description and appended claims, taken in conjunction with the accompanying drawings.

### BRIEF DESCRIPTION OF THE DRAWINGS

FIG. 1 is a perspective view of a vehicle seat including piezoelectric energy generating devices that generate energy as a result of person sitting and/or moving in the seat;

FIG. 2 is a top view of one of the piezoelectric energy generating devices separated from the seat;

FIG. 3 is a side view of the piezoelectric energy generating device separated from the seat;

FIG. 4 is a cut-away plan view of a vehicle console area including an energy storage device that stores energy generated from human activity and a power port from which the energy can be accessed;

FIG. 5 is a cut-away plan view of a vehicle driver's seat area showing various structures that can include power generating devices;

FIG. 6 is a broken-away perspective view of an inside of a vehicle door showing a collapsible manual window crank assembly for lowering and raising a window in the vehicle door and generating electrical energy;

FIG. 7 is a perspective view of the manual window crank assembly shown in FIG. 1 in a rotating position; and

FIG. 8 is a blown-apart perspective view of the manual window crank assembly of FIG. 6 showing how it is engaged and disengaged from the window.

### DETAILED DESCRIPTION OF THE EMBODIMENTS

The following discussion of the embodiments of the invention directed to a system and method for collecting energy from human activity and providing that energy in a vehicle for in-vehicle use is merely exemplary in nature, and is in no way intended to limit the invention or its applications or uses.

FIG. 1 is a perspective view of a seat 10 for a vehicle. The seat 10 is most likely a driver's seat of the vehicle. However, the seat 10 is intended to represent any seat in the vehicle, including passenger seats, back seats, etc., that has application for the purposes described herein The seat 10 includes a seat portion 12, a back portion 14 and a head rest 16. The seat portion 12 can include any configuration of seat components for the purposes described herein, such as a suitable foam material mounted on springs and covered by a suitable covering, such as leather. A plurality of piezoelectric energy generating devices 20 are mounted within the seat portion 12 at a suitable location and electrically coupled in series for the purposes described herein. In this non-limiting example, there are fifteen of the piezoelectric devices 20 provided in three rows. Other configurations of the devices 20 may be equally applicable.

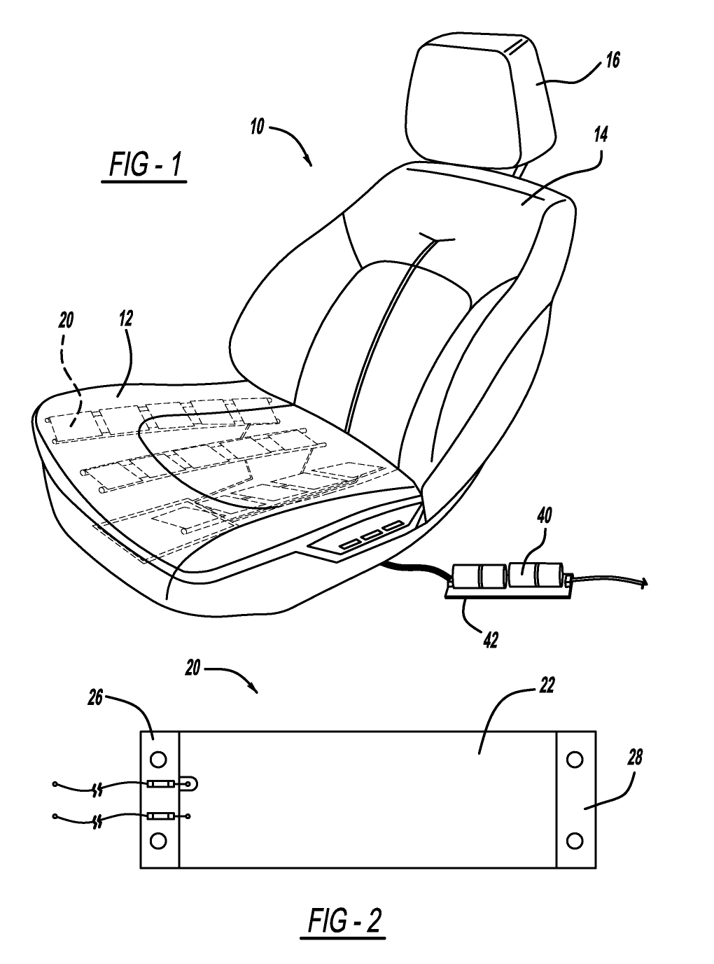

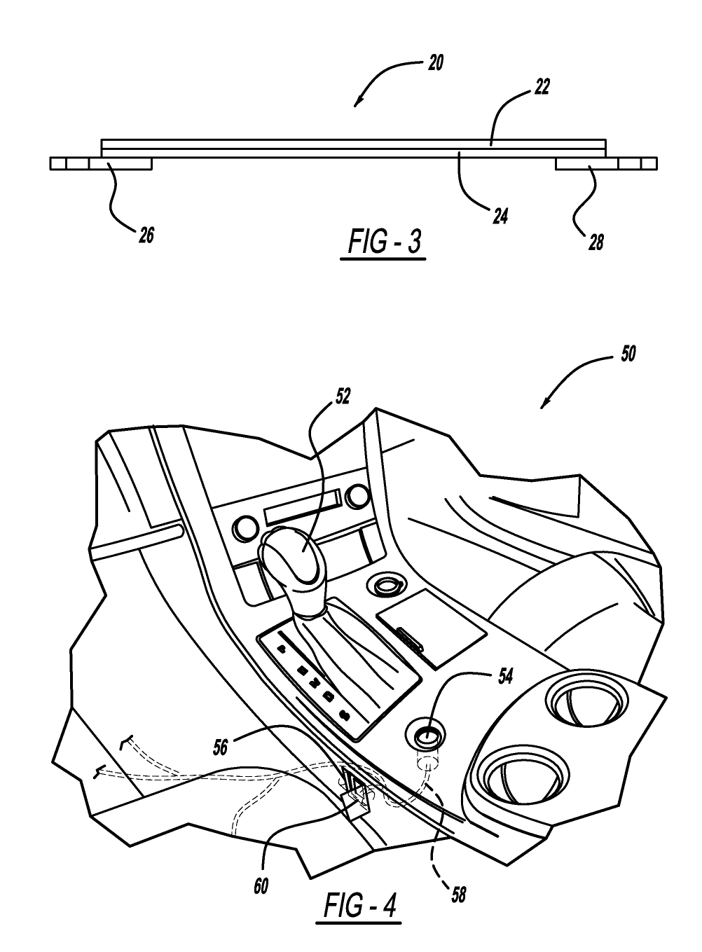

FIG. 2 is a top view and FIG. 3 is a side view of one of the piezoelectric energy generating devices 20 separated from the seat 10. The piezoelectric energy generating devices 20 are layered devices that can be configured in various types of designs. In one known design, the piezoelectric devices 20 are bending generators where piezoelectric layers 22 and 24 generate electricity as a result of the layers 22 and 24 being bent, such as by the weight of the occupant sitting in the seat 10. In an alternate embodiment, the piezoelectric devices 20 generate electricity as a result of movement of the occupant in the seat 10 where fibers in the device 20 generate electricity as a result of this movement. The piezoelectric devices 20 include mounting plates 26 and 28 at each end of the layers 22 and 24 that allow the device 20 to be mounted to the seat portion 12 at the desirable location. Thus, as the seat occupant sits on the seat portion 12 and moves relative thereto during normal driving of the vehicle, energy is continually, or at least intermittently, generated by the piezoelectric devices 20 that can be stored.

The discussion above talks about two types of piezoelectric energy generating devices suitable for the present invention. However, other types of piezoelectric devices may also applicable for the purposes described herein. Any suitable piezoelectric material or piezoelectric film can be employed that generates electricity from the activity of a human. Also, piezoelectric nanowire fibers may also be employed in the fabric of the seat 10 and piezoelectric spacers could be mounted between the seat tracks and the vehicle load floor for generating electrical energy from the weight of the occupant in the seat 10.

The size of the piezoelectric devices 20, the number of the piezoelectric devices 20, the location of the piezoelectric devices 20, etc. would all depend on the specific vehicle, application, energy to be generated, etc. Although the piezoelectric devices 20 are shown in the seat portion 12, in alternate embodiments, the piezoelectric devices 20 could also be positioned in the back portion 14 and/or the head rest 16. Further, although piezoelectric energy generators are used to collect energy from human activity in the embodiment discussed above, other types of energy collecting devices may be employed that are suitable for this purpose, such as devices that capture body heat, energy producing fabrics, etc.

Once the energy is generated by the piezoelectric devices 20 it needs to be collected in some type of energy storage device. FIG. 1 shows two electrical energy storage devices 40 electrically coupled to the piezoelectric devices 20 that collect and store the electrical energy generated by the devices 20. The present invention contemplates any suitable energy storage device, such as rechargeable batteries, that is applicable for the purposes described herein. The storage devices 40 are mounted in a cradle 42 in a manner so that the devices 40 can be removed therefrom. The cradle 42 can be mounted at any suitable location in the vehicle, possibly in the seat 10, maybe in the dashboard of the vehicle, etc.

Power from the storage devices 40 is provided to a power point (discussed below) on the vehicle from which the collected energy can be used. The power point can be any suitable power point for a particular application, such as those that resemble cigarette lighter receptacles found on modern vehicles. The vehicle user can access the power by directly coupling a suitable receptacle into the power point and connecting it to a suitable electrically driven device, such as a GPS locator, low current lighting, cell phone, etc. The present invention contemplates using the collected energy by any suitable device in a vehicle that uses low power, such as portable GPS locators, cell phones, iPods, low current lighting, etc. Further, in addition to direct electrical connection between the receptacle and the load, an inductive coupling connection can be provided where the energy is transferred to the load by inductive coupling.

As mentioned above, the storage devices 40 can be removed from the cradle 42. The present invention also contemplates generating electricity from human activity outside of the vehicle, and then bringing the collected energy into the vehicle to be used at the power point location. For example, as discussed above, a knee brace is known in the art that generates and stores electricity from the operation of a person walking. Such a device can be used to collect energy by the storage devices 40, and the storage devices 40 can then be transferred to the vehicle and inserted in the cradle 42 to be used in the vehicle. The present invention contemplates any device that generates and collects energy as a result of human activity that can then be brought into the vehicle.

FIG. 4 is a cut-away plan view of a vehicle console area 50 including a gear shifter 52. The console 50 includes an eco-power access port 54 of the type described above. A rechargeable electric storage device 56 is inserted into the console 50 through an opening 60 where the storage device 56 can be removed therefrom so that the power sources from outside the vehicle can be brought into the vehicle, as discussed above. Wires 58 are coupled to the various charge generating devices discussed herein that can recharge the storage device 56 when it is on the vehicle.

The discussion above is directed to passively collecting energy from human activity. In an alternate embodiment, the vehicle operator can actively operate some energy generating device that generates electricity and allows it to be collected and stored in the energy storage devices 40. For example, the left foot rest that is provided on most vehicles can be equipped with a suitable energy collecting device, such as the piezoelectric devices discussed above, where pressure applied by the vehicle operator onto the foot rest causes energy to be generated and collected by the energy storage devices 40. Other suitable examples include placing such energy collecting devices in the steering wheel of the vehicle or on the gear shifter 52 where a grabbing pressure by the vehicle operator generates the electricity, which is collected.

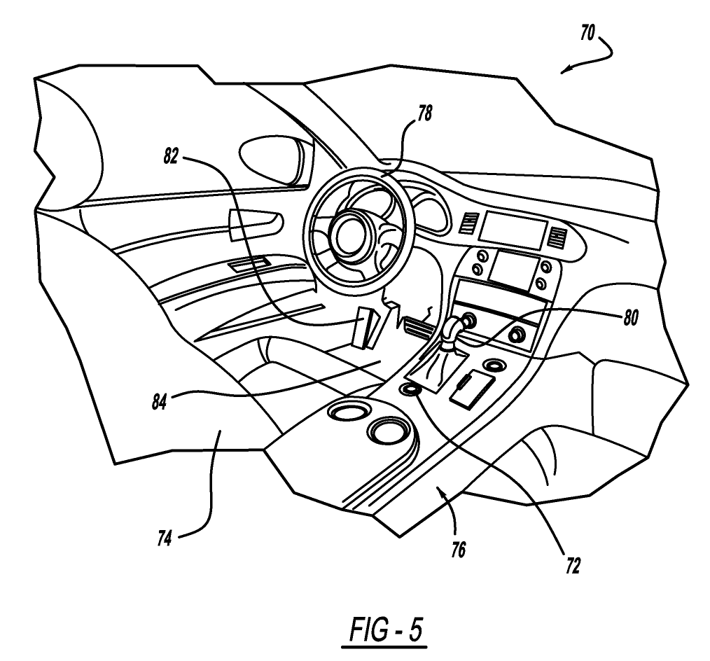

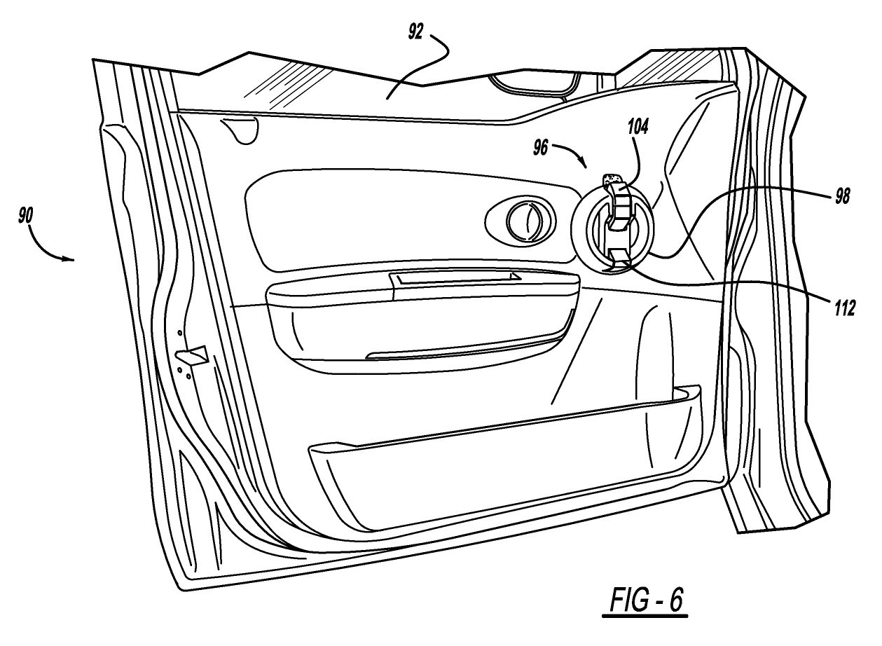

FIG. 5 is a cut-away perspective view of a driver's seat area 70 of a vehicle showing a console 76 including a gear shifter 80 and an eco-power access port 72. Power is provided to the eco-power port 72 in the manner as discussed above from various devices in the driver's seat area 70, such as from a driver's seat 74, a left foot rest 82, a steering wheel 78 and the gear shifter 80. Additionally, the carpet 84 can be provided with the piezoelectric nanowire fibers to generate electricity as the person rubs against the carpet 84 during operation of the vehicle.

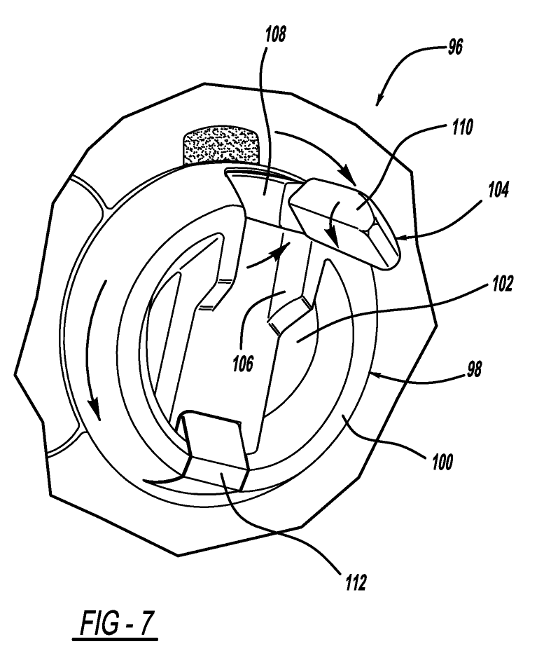

FIG. 6 is a perspective view of an inside of a vehicle door 90 including a vehicle window 92. The vehicle door 90 includes a collapsible manual window crank assembly 96 including a crank housing 98 that is rotatable to raise and lower the window 92. FIG. 7 is a broken-away view of the window crank assembly 96 in its operational state being rotated to raise or lower the window 92. The crank housing 98 includes an outer perimeter portion 100 defining a central opening 102. A two-piece handle 104 is stowed within a channel 106 when the crank assembly 106 is in its collapsed state. An operator lifts the handle 104 to the operational state to the position shown in FIG. 7 where it can be rotated to raise and lower the window 92. When the handle 104 is lifted, a base portion 108 of the handle 104 mounted to the housing 98 is extended and a rotatable portion 110 rotatably mounted to the base portion 108 is rotated. The vehicle operator will grasp the rotatable portion 110 and rotate the housing 98 to raise and lower the window 92 depending on the direction the housing 98 is rotated. As the operator turns the housing 98, the rotatable portion 110 rotates on the base portion 108 of the handle 104.

According to the invention, the window crank assembly 96 can also be used to drive a generator to generate and store electrical energy. The crank assembly 96 can be rotated to raise and lower the window 92 and generate electricity and can be rotated solely to generate the electrical energy where it is disengaged from the window 92 to allow the vehicle operator to generate power without moving the window 92.

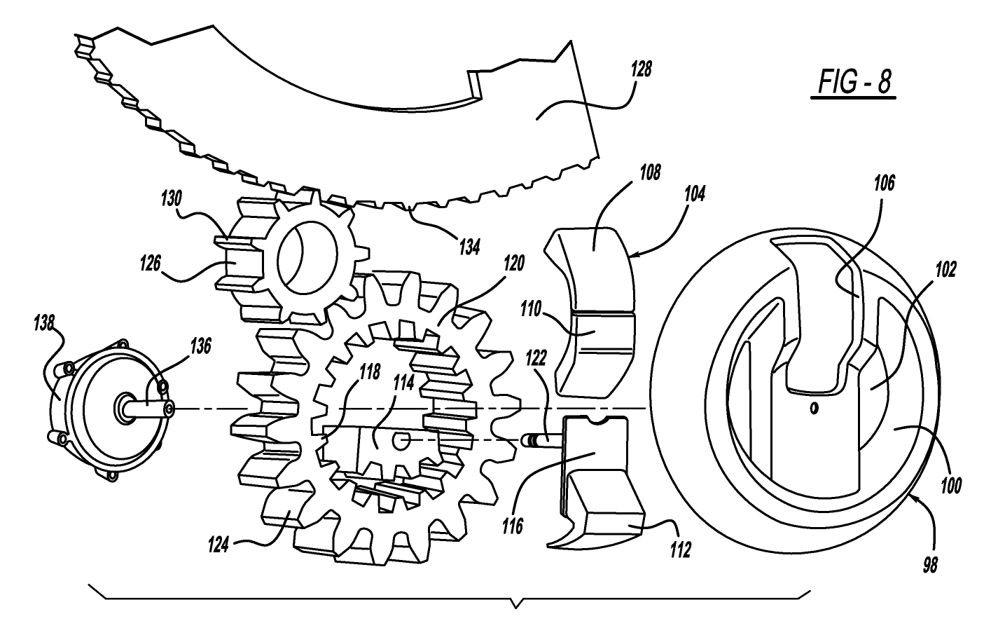

FIG. 8 is a blown-apart perspective view of one exemplary design of the window crank assembly 96 for its purpose. The assembly 96 includes a switch 112 mounted to a switch plate 116 that can be put into a generator position or a window/generator position depending on whether rotating the crank housing 98 will be used to raise or lower the window 92 and generate electricity or just generate electricity. Lowering the switch 112 puts the assembly 96 in the window/generator position by causing a switch pin 122 to push a switch gear 114 into engagement with internal teeth 118 of a main gear 120. External teeth 124 on the main gear 120 engage teeth 130 of a smaller gear 126, which engage the teeth 134 of a fan gear 128 that is coupled to the window 92. Thus, rotating the crank housing 98 clockwise or counter-clockwise will rotate the main gear 120 clockwise or counter-clockwise to raise or lower the window 92.

A generator 138 is mounted within a central opening of the main gear 120 and includes a shaft 136 rigidly mounted to a center point of the crank housing 98. Thus, rotating the crank housing 98 will cause the shaft 136 to rotate to operate the generator 138 and generate the electricity.

Raising the switch 112 will cause the switch pin 122 to raise the switch gear 114 and disengage it from the main gear teeth 118 so that when the crank housing 98 rotates only the switch gear 114 rotates. The main gear 120 will not rotate and thus the window 92 will not move. Because the generator shaft 136 is still coupled to the crank housing 98, rotating the crank housing 98 will still generate electricity.

Wires (not shown) would be coupled to a battery or some other electrical storage device (not shown) so that the energy generated by the generator 138 can be used at a later time. The electricity can be stored at any suitable location on the vehicle or otherwise, and can be used to power any suitable vehicle device, such as dome lights, seat lumbar supports, moon roofs, etc.

The present invention contemplates any suitable manual crank on a vehicle for performing any suitable operation, where the crank can be engaged and disengaged from the particular device. Also, the power generating crank can be a stand-alone unit provided at any suitable location on the vehicle whose sole purpose is to generate electrical energy where the vehicle operator or passengers can rotate the crank to generate the energy for later use.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for providing electrical energy on a vehicle, said system comprising:
at least one energy generating device that generates electrical energy as a result of human motion;
an electrical storage device that collects and stores electrical energy from the energy generating device; and
a power access port on the vehicle and being electrically coupled to the electrical storage source, said power access port providing power to low power devices.

2. The system according to claim 1 wherein the energy generating device is a piezoelectric device.

3. The system according to claim 2 wherein the piezoelectric device generates electrical energy as a result of bending the piezoelectric device.

4. The system according to claim 2 wherein the piezoelectric device generates electrical energy as a result of motion of the piezoelectric device.

5. The system according to claim 2 wherein the piezoelectric device includes piezoelectric nanofibers.

6. The system according to claim 2 wherein the piezoelectric device includes a piezoelectric film.

7. The system according to claim 1 further comprising a vehicle seat, said at least one energy generating device being mounted within the seat.

8. The system according to claim 1 further comprising a human motion device external to the vehicle, said at least one energy generating device and said electrical storage device being mounted to the human motion device and said electrical storage device being transferrable to the vehicle.

9. The system according to claim 8 wherein the human motion device is a knee brace.

10. The system according to claim 1 further comprising a vehicle foot-rest, said at least one energy generating device being mounted in the vehicle foot-rest.

11. The system according to claim 1 further comprising a vehicle steering wheel, said at least one energy generating device being positioned within the vehicle steering wheel.

12. The system according to claim 1 further comprising a vehicle gear shifter, said at least one energy generating device being positioned within the vehicle gear shifter.

13. The system according to claim 1 further comprising vehicle floor carpeting, said at least one energy generating device being piezoelectric nanowires formed in the fabric of the carpeting.

14. A system for providing electrical energy on a vehicle, said system comprising;
a vehicle seat including a seat portion and a back portion;
a plurality of piezoelectric energy generating devices formed in the seat portion of the seat, and generating electricity as a result of a person being seated in the seat;
an electrical storage device for collecting and storing the electrical energy generated by the plurality of energy generating devices in the seat; and
a power access port on the vehicle that is electrically coupled to the electrical storage device, and being operable to provide power to low power devices.

15. The system according to claim 14 wherein the energy generating device is a piezoelectric device.

16. The system according to claim 14 further comprising a vehicle foot-rest, said at least one energy generating device being mounted in the vehicle foot-rest.

17. The system according to claim 14 further comprising a vehicle steering wheel, said at least one energy generating device being positioned within the vehicle steering wheel.

18. The system according to claim 14 further comprising a vehicle gear shifter, said at least one energy generating device being positioned within the vehicle gear shifter.

19. The system according to claim 14 further comprising vehicle floor carpeting, said at least one energy generating device being piezoelectric nanowires formed in the fabric of the carpeting.

20. A system for providing electrical energy on a vehicle, said system comprising:
a human motion device external to the vehicle, said human motion device including at least one energy generating device that generates electrical energy as a result of human motion;
an electrical storage device that collects and stores electrical energy from the energy generating device, said electrical storage device being transferrable to the vehicle; and
a power access port on the vehicle and being electrically coupled to the electrical storage source, said power access port providing power to low power devices.

21. The system according to claim 20 wherein the energy generating device is a piezoelectric device.

22. The system according to claim 20 wherein the human motion device is a knee brace.

23. A manual crank assembly for raising and lowering a vehicle window, said crank assembly comprising:
a rotatable housing;
a generator coupled to the rotatable housing and generating electricity upon rotation of the rotatable housing;
a series of gears selectively coupled between the rotatable housing and the window; and
a selector switch for engaging and disengaging the series of gears so that the rotatable housing can be selectively coupled to and decoupled from the window so that it can be used to raise or lower the window and generate electricity or just generate electricity.

24. The assembly according to claim 23 wherein the series of gears includes a main gear having internal teeth and external teeth and a switch gear coupled to the selector switch where the selector switch raises and lowers the switch gear to engage and disengage the internal teeth of the main gear.

25. The assembly according to claim 24 wherein the series of gears includes a transition gear in engagement with the external teeth of the main gear and a fan gear in engagement with the transition gear, said fan gear being coupled to the window so that when the selector switch causes the switch gear to be coupled to the main gear, rotation of the rotatable housing raises and lowers the window.

26. The assembly according to claim 24 wherein the generator is positioned within the main gear.

27. The assembly according to claim 23 wherein the rotatable housing is circular and a shaft of the generator is coupled to a center of the rotatable housing.

28. The assembly according to claim 23 further comprising a handle including a base portion and a rotatable portion, said rotatable portion being rotatable relative to the base portion and being rotatable to rotate the rotatable housing to operate the crank assembly.

29. A manual crank assembly for providing electrical energy, said crank assembly comprising:
a circular rotatable housing;
a handle mounted to the housing, said handle including a first portion secured to the housing and a second portion secured to the first portion, said second portion being rotatable relative to the first portion to rotate the rotatable housing; and
a generator including a generator shaft, said generator shaft being mounted to a center of the rotatable housing so that upon rotation of the rotatable housing, the generator shaft is rotated causing the generator to generate electricity.
